(19) United States
(12) Patent Application Publication
(10) Pub. No.: US 2009/0311356 A1
(43) Pub. Date: Dec. 17, 2009

(54) Dosing Apparatus

(76) Inventors: James S. Belt, Utica, OH (US); Jonathan M. Verhoff, Reynoldsburg, OH (US)

Correspondence Address: OWENS CORNING, 2790 COLUMBUS ROAD, GRANVILLE, OH, 43023, US

(21) Appl. No.: 12/139,125

(22) Filed: Jun. 13, 2008

(51) Int. Cl. B28B 13/02

(52) U.S. Cl. 425/120

(57) ABSTRACT

An apparatus for manufacturing simulated masonry products is provided. The apparatus comprises a mold having a mold cavity. The mold cavity has a top surface. An applicator pan is positioned adjacent to the mold. The applicator pan has a screen section positioned above the top surface of the mold cavity. The screen section includes an aperture. The aperture is configured to prevent castable material residing in the applicator pan from flowing through the aperture and into the mold cavity without additional influence A flow mechanism is configured to urge the flow of the castable material through the aperture and into the mold cavity.

### TECHNICAL FIELD

This invention relates to simulated masonry products. More particularly this invention relates to molds and hoppers for manufacturing simulated masonry products.

### BACKGROUND OF THE INVENTION

Simulated masonry products include simulated brick, simulated pavers, simulated stone veneers and simulated stone architectural trim products. Simulated masonry products are used as a lightweight veneer facing on masonry, and on metal framed or wood framed construction for architectural aesthetics. The products can be used for exterior applications such as building walls or interior applications such as fireplaces. Simulated stone architectural trim products include capstones, hearthstones, keystones, trim stones and the like. The simulated masonry products are usually lower in cost than the brick or natural stones that they replace.

CULTURED STONE® products are simulated masonry products manufactured by Owens Corning Masonry Products, a division of Owens Coming headquartered in Toledo, Ohio. The CULTURED STONE® product line includes hundreds of designs of precast masonry veneers and architectural trim products that replicate an extensive variety of textures, sizes, shapes and colors of natural stone. The products are manufactured using molds taken from bricks and natural stones. The molds generally include a mold cavity filled with a castable material. After the castable material has cured, or set, the simulated masonry products are removed from the mold.

It is especially desired to have many types and shades of simulated masonry products. It would be advantageous if simulated masonry products could be manufactured more efficiently.

### SUMMARY OF THE INVENTION

According to this invention there is provided an apparatus for manufacturing simulated masonry products. The apparatus comprises a mold having a mold cavity. The mold cavity has a top surface. An applicator pan is positioned adjacent to the mold. The applicator pan has a screen section positioned above the top surface of the mold cavity. The screen section includes an aperture. The aperture is configured to prevent castable material residing in the applicator pan from flowing through the aperture and into the mold cavity without additional influence. A flow mechanism is configured to urge the flow of the castable material through the aperture and into the mold cavity.

According to this invention there is provided an apparatus for manufacturing simulated masonry products. The apparatus comprises a mold having a mold cavity. The mold cavity has a top surface. An applicator pan is positioned adjacent to the mold. The applicator pan has a screen section positioned above the top surface of the mold cavity. The screen section includes an aperture. The aperture is configured to prevent castable material residing in the applicator pan from flowing through the aperture and into the mold cavity without additional influence. A mold vibrator is configured to urge the flow of the castable material through the aperture and into the mold cavity.

According to this invention there is also provided a method for manufacturing simulated masonry products. The method comprises providing a mold having a mold cavity, the mold cavity having a top surface, providing an applicator pan, the applicator pan having a screen section, the screen section including an aperture, positioning the applicator pan relative to the mold so that the screen section is positioned above and aligned with the top surface of the mold cavity, providing castable material to the applicator pan, wherein the castable material and the applicator pan are configured to coordinate with each other such that the Theological properties of the castable material are sufficient to prevent the flow of the castable material through the aperture in the applicator pan in the absence of additional flow influences, urging the flow of the castable material through the aperture of the applicator pan such that the castable material flows into the mold cavities, allowing the castable material to harden to form simulated masonry products, and removing the simulated masonry product from the at least one mold cavity.

Various objects and advantages will become apparent to those skilled in the art from the following detailed description of the invention, when read in light of the accompanying drawings. It is to be expressly understood, however, that the drawings are for illustrative purposes and are not to be construed as defining the limits of the invention.

### BRIEF DESCRIPTION OF THE DRAWINGS

FIG. 1 is a perspective view of a portion of a mold for a simulated masonry product.

FIG. 2A is a schematic perspective view, partially in phantom, of a mold cavity of the mold shown in FIG. 1.

FIG. 2B is a schematic perspective view of a second embodiment of a mold cavity.

FIG. 3 is a side elevational view of the mold of FIG. 1 taken along line 3-3 of FIG. 1.

FIG. 4 is a side elevational view of a mold dosing apparatus for a simulated masonry product.

FIG. 5 is a schematic perspective view of a pan applicator of the mold dosing apparatus of FIG. 4.

FIG. 6A is a plan view of an applicator screen of the pan applicator of FIG. 5 shown as a flat member.

FIG. 6B is a plan view of a second embodiment of the applicator screen of the pan applicator of FIG. 5.

FIG. 6C is a plan view of a third embodiment of the applicator screen of the pan applicator of FIG. 5.

FIG. 6D is a plan view of a fourth embodiment of the applicator screen of the pan applicator of FIG. 5.

FIG. 7 is a side elevational view of the mold dosing apparatus of FIG. 4 illustrating the mold in contact with the pan applicator.

FIG. 8A is a side view, of a portion of the mold dosing apparatus of FIG. 4, illustrating the flow of castable material from a supply hopper to the applicator pan.

FIG. 8B is a side view, of a portion of the mold dosing apparatus of FIG. 4, illustrating the flow of castable material from the applicator pan to the mold cavity.

FIG. 8C is a side view, of a portion of the mold dosing apparatus of FIG. 4, illustrating the castable material in the mold cavity.

FIG. 8D is a side view, of a portion of the mold dosing apparatus of FIG. 4, illustrating separation of the applicator pan from the mold.

FIG. 9 is a schematic perspective view of a simulated masonry product illustrating a front face.

FIG. 10 is a schematic perspective view of a simulated masonry product illustrating a back face.

### DETAILED DESCRIPTION OF THE INVENTION

Simulated corner masonry products can be in the form of corner pieces, corner hearth pieces and coiner architectural trim pieces as well as other corner-shaped products. Simulated corner masonry products are manufactured using a mold filled with castable material flowing from a hopper.

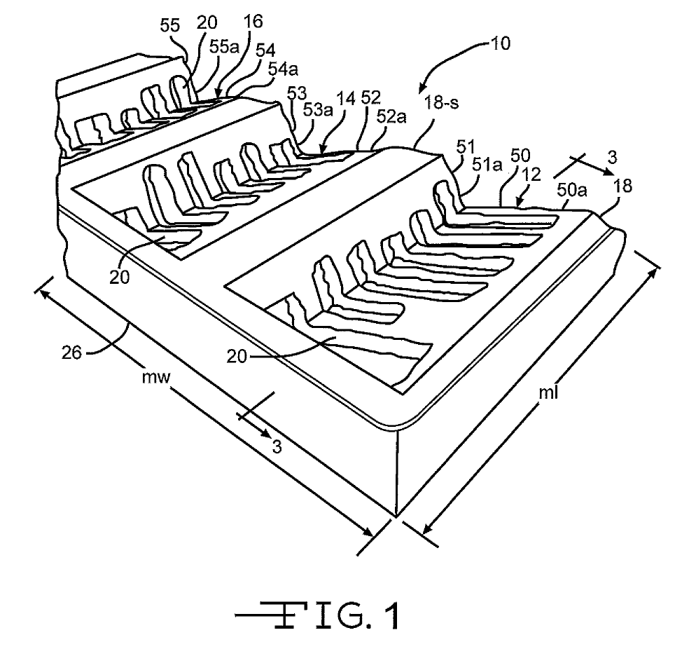

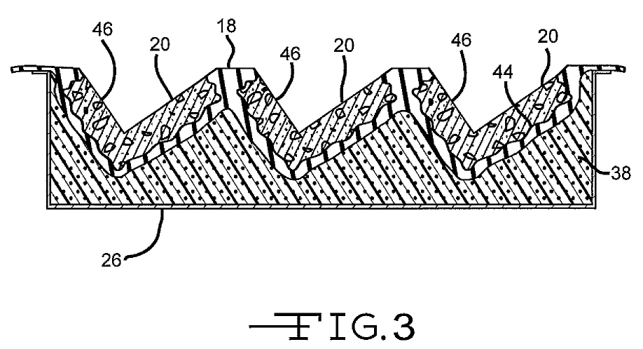

Referring now to FIG. 1, a mold 10 includes at least one flexible layer 18 having one or more rows, 12, 14 and 16 of mold cavities 20. While the mold 10 shown in FIG. 1 includes three rows, 12, 14 and 16 of mold cavities 20, it should be understood that more or less than three rows of mold cavities 20 can be used. As shown in FIG. 3, the mold cavities 20 are configured to receive a castable material 46 and shape the castable material 46 into simulated masonry products. The castable material 46 can be any material, such as concrete, plaster of paris or gypsum, suitable for being molded into simulated corner masonry products. Referring again to FIG. 1, in this embodiment, rows 12 and 14 of mold 10 are each illustrated as having six mold cavities 20. Alternatively, the rows 12, 14 and 16 of mold 10 can have any number of mold cavities 20. As shown in FIG. 1, the mold cavities 20 can have different shapes and sizes.

As shown in FIG. 1, the mold 10 has a mold length ml and a mold width mw. The mold length ml and the mold width mw are configured to accommodate the desired number of rows and the desired number of mold cavities 20. It will be appreciated that the mold length ml and the mold width mw will change depending on the quantity and size of mold cavities 20 located within the rows of the mold 10.

The flexible layer 18 is configured to include the mold cavities 20 and to flex when the simulated masonry products are removed from the mold cavities 20. The flexible layer 18 can be made from one or more layers of a suitable flexible material, such as a curable elastomeric, latex or silicone rubber, or any other material suitable to include the mold cavities 20 and to flex when the simulated masonry products are removed from the mold cavities 20.

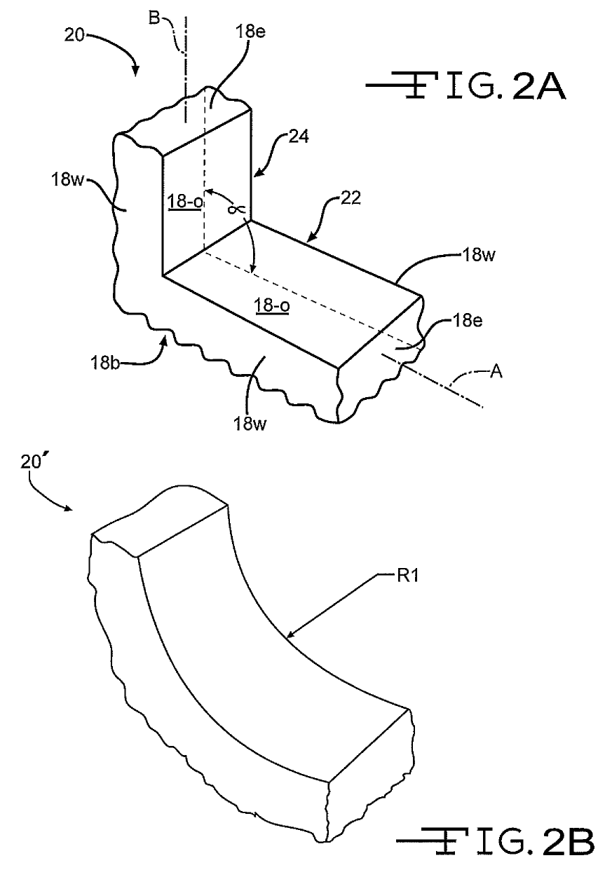

As shown in FIG. 2A, the mold cavities 20 have a corner shape. The mold cavities 20 have a first section 22 having a first longitudinal axis A that is in communication with a second section 24 having a second longitudinal axis B. The intersection of the first longitudinal axis A of the first section 22 and the second longitudinal axis B of the second section 24 form a cavity angle α. The cavity angle α is configured to provide a desired surface and angle for attachment of the simulated masonry product to a support structure. In this embodiment, the cavity angle α is a 90° angle. Alternatively, the cavity angle α can be any angle, more or less than 90° sufficient to provide a desired surface and angle for attachment of the simulated masonry product to a support structure.

In another embodiment as shown in FIG. 2B, the mold cavity 20′ has a radiused shape for use with desired architectural effects. In this embodiment, the mold cavity 20′ has a radius R1. The radius R1 can be any suitable radius. While the embodiment shown in FIG. 2A provides a corner shaped masonry product and the embodiment shown in FIG. 2B provides a radiused masonry product, it should be understood that the mold 10 can be configured to provide any shape of masonry product and in any dimension.

Referring again to FIG. 2A, the first and second sections 22 and 24 of the mold cavity 20 have different lengths. The different lengths of the first and second sections 22 and 24 of the mold cavity 20 are configured to provide a desired aesthetic appearance of the simulated masonry product. In the illustrated embodiment, the first section 22 is about two to four times longer than the second section 24. In another embodiment, the first section 22 can be more or less than about two to four times longer than the second section 24. Alternatively, the first and second sections 22 and 24 of the mold cavity 20 can have substantially the same length or the second section 24 can be longer than the first section 22.

The first and second mold cavity sections 22 and 24 have an end wall 18-e and opposing sidewalls 18-w. The opposing sidewalls 18-w and the end walls 18-c form the outer perimeters of the first and second sections 22 and 24. The mold cavity sections 22 and 24 have a bottom 18-b and an opposing, top openings 18-o. The mold cavity sidewalls 18-w, the end walls 18-e and the bottom 18-b have a stone textured surface.

In certain embodiments as shown in FIG. 1, the flexible layer 18 also has support sections 18-s. The support sections 18-s are defined by the areas surrounding the mold cavity sidewalls 18-w and the mold cavities 20. The support sections 18-s divide the mold 10 into the individual mold cavities 20. In certain embodiments, the support sections 18-s have a flexible modulus that is stiffer or more rigid than the flexural modulus of the mold cavity bottom 18-b, the end walls 18-e, and the mold cavity sidewalls 18-w.

In certain embodiments, the flexible layer 18 can include a reinforcing material (not shown). The reinforcing material is added to, or encapsulated within, the sidewalls 18-w. The reinforcing material reinforces the sidewalls 18-w, yet allows the sidewalls 18-w to still retain the desired flexibility. In certain embodiments, the reinforcing material can comprise a paste-like material, comprising, for example, a latex material, ground up rubber tires, sawdust, and MgO composition.

In certain embodiments as shown in FIGS. 1 and 3, the mold 10 includes a mold frame 26. The mold frame 26 is configured to hold the flexible layer 18. In the illustrated embodiment, the mold frame 26 is made of a rigid material, such as for example metal. In other embodiments, the mold frame 26 can be made of other rigid materials, such as reinforced plastic, sufficient to hold the flexible layer 18.

Referring again to FIG. 3, a support material 38 is positioned between the mold frame 26 and the flexible layer 18. The support material 38 is configured to be a load supporting material capable of providing substantially rigid structural support to the flexible layer 18. The support material 38 can be any type of structural material such as, for example, foams such as polyurethane, polystyrene and polyphenylene oxide, or any other type of material sufficient to be a load supporting material capable of providing substantially rigid structural support to the flexible layer 18.

In another embodiment, the mold 10 can be made from a solid block of material. The mold 10 material can be any material suitable to form a mold 10 containing mold cavities 20 for producing simulated masonry products. Examples of suitable material include latex rubber, elastomers such as polyurethane, and thermoplastics such as polyvinyl chloride.

In certain embodiments as shown in FIG. 3, the mold cavities 20 are painted with a layer 44 of one or more suitable stone-colored paints. In certain embodiments, especially where the flexible layer 18 has deep and/or narrow sidewalls 18-w and end walls 18-e, the painting of such vertical surfaces can be done by flexing the flexible layer 18 to open up the mold cavity 20 and allow easier painting of the end walls 18-e, the sidewalls 18-w and the bottom 18-b.

Referring again to FIG. 1, the mold 10 includes first mold sides 50, 52 and 54, and second mold sides 51, 53 and 55. The mold 10 is configured such that the first sections 22 of the mold cavities 20 are disposed within the first mold sides 50, 52 and 54. Similarly, the second sections 24 of the mold cavities 20 are disposed within the second mold sides 51, 53 and 55. In another embodiment, the first sections 22 of the mold cavities 20 could be disposed within the second mold sides 51, 53 and 55 and the second sections 24 of the mold cavities 20 could be disposed within the first mold sides 50, 52 and 54.

As shown in FIG. 1, the first mold sides 50, 52 and 54 have first side top surfaces 50a, 52a and 54a. Similarly, the second mold sides 51, 53 and 55 have second side top surfaces 51a, 53a and 55a.

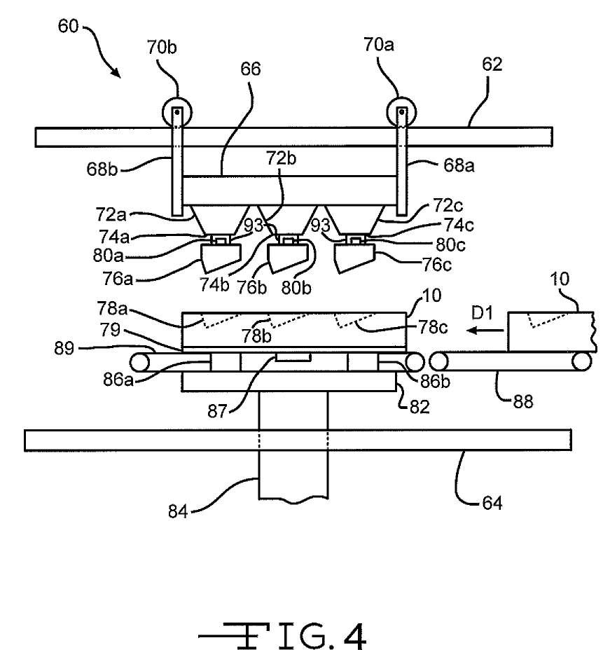

Referring now to FIG. 4, there is illustrated mold dosing apparatus, indicated generally at 60, for use in manufacturing masonry products. The term “dosing” as used herein, is defined to mean the use of select quantities of castable material to manufacture masonry products. The mold dosing apparatus 60 includes a first framework 62 and a second framework 64. The first framework 62 supports an applicator framework 66. As shown in FIG. 4, the applicator framework 66 includes risers 68a and 68b. The risers, 68a and 68b, ate connected to traveling mechanisms 70a and 70b, respectively. The traveling mechanisms, 70a and 70b, are configured to allow for lateral movement of the applicator framework 66 along the first framework 62. The applicator framework 66 is moved along the first framework 62 for purposes of cleaning and servicing the applicator framework 66. In the illustrated embodiment, the traveling mechanisms, 70a and 70b, are rollers. In other embodiments, the traveling mechanisms, 70a and 70b, can be any suitable device or mechanism, such as for example a conveyor, sufficient to allow for lateral movement of the applicator framework 66 along the first framework 62. While the illustrated embodiment provides for lateral movement of the applicator framework 66 along the first framework 62, it should be understood the in other embodiments, the applicator framework 62 could be move in other directions, such as perpendicular to the first framework 62.

Referring again to FIG. 4, the applicator framework 66 includes a plurality of supply hoppers 72a-72c. The supply hoppers 72a-72c are configured to supply castable material (not shown) to a plurality of applicator pans 76a-76c. The supply hoppers 72a-72c can be made of any material, such as metal or reinforced plastic, sufficient to contain the castable material and supply the castable material to the applicator pans 76a-76c. The supply hoppers 72a-72c include supply hopper exits, 74a-74c, respectively. In the illustrated embodiment, the supply hoppers 72a-72c have an inverted trapezoidal cross-sectional shape. The inverted cross-section shape of the supply hoppers, 72a-72c, is configured to guide the castable material (not shown) to a supply hopper exits 74a-74c. In other embodiments, the supply hoppers, 72a-72c, can have other suitable cross-sectional shapes, sufficient to guide the castable material to the supply hopper exits 74a-74c. While the illustrated embodiment shows three supply hoppers 72a-72c, it should be understood that more or less than three supply hoppers can be used.

As shown in FIG. 4, the plurality of applicator pans, 76a-76c, are positioned below the supply hopper exits 74a-74c. As will be explained in more detail below, the applicator pans 76a-76c are configured to contact the mold 10 such that each of the applicator pans 76a-76c seats against the top surfaces 50a-55a of a corresponding row 78a-78c of mold cavities 20.

Referring again to FIG. 4, a plurality of pan vibrators 80a-80c are attached to the applicator pans, 76a-76c. The pan vibrators, 80a-80c, are configured to vibrate the applicator pans, 76a-76c, thereby promoting a flow of castable material through the applicator pans, 76a-76c, to the mold 10. In the illustrated embodiment, the pan vibrators, 80a-80c, are pneumatic, piston-type vibrators providing a liner force. One example of a pneumatic, piston-type of vibrator is the Houston Series, model number BV-150 QI, marketed by Chicago Vibrator Products, headquartered in Westmont, Ill. In other embodiments, the pan vibrators can be other suitable vibrators, such as for example electric or rotary vibrators, sufficient to promote a flow of castable material through the applicator pans, 76a-76c, to the mold 10.

Referring again to FIG. 4, the pan vibrators 80a-80c are attached to the applicator pans, 76a-76c. As will be explain in more detail below, the applicator pans 76a-76c are connected to the supply hoppers, 72a-72c, such that vibration caused by the pan vibrators 80a-80c is substantially isolated to the applicator pans 76a-76c.

As shown in FIG. 4, the mold 10 is positioned on a mold table 79 located on a mold lift frame 82. The mold table 79 is supported by mold isolation mechanisms 86a and 86b. The mold isolation mechanisms, 86a and 86b, are configured to isolate the mold 10 as the mold is vibrated by a mold vibrator 87. In the illustrated embodiment, the mold isolation mechanisms, 86a and 86b, are air bags. In other embodiments, the mold isolation mechanisms, 86a and 86b, can be other mechanisms or devices, such as for example elastomeric isolators, sufficient to isolate the mold 10 as the mold is vibrated by the mold vibrator 87. The mold table 79 and the mold lift frame 82 are configured to retain the mold 10 in a fixed horizontal position as the mold 10 is raised vertically to a position against the pan applicators 76a-76c. In the illustrated embodiment, the mold table 79 and the mold lift frame 82 are made of steel. In other embodiments, the mold table 79 and the mold lift frame 82 can be made of other materials, such as for example aluminum, sufficient to retain the mold 10 in a fixed horizontal position as the mold 10 is raised vertically to a position against the pan applicators 76a-76c.

Referring again to FIG. 4, the mold lift frame 82 is connected to a mold lift cylinder 84. The mold lift cylinder 84 is configured to vertically raise and lower the mold lift frame 82. In the illustrated embodiment, the mold lift cylinder 84 is a hydraulic cylinder having a piston diameter of approximately 6.0 inches. In other embodiments, the mold lift cylinder 84 can be other types of mechanisms, such as for example pneumatic or electric cylinders, or rack and pinion mechanisms, sufficient to vertically raise and lower the mold lift frame 82. In other embodiments, the mold lift cylinder 84 can have any suitable piston diameter. The vertical travel of the mold lift cylinder 84 can be limited and adjusted by lift limits (not shown). In one embodiment, the lift limits are mechanical stops. In other embodiments, the lift limits can be other mechanisms or devices, such as for example electrical limits, sufficient to limit and adjust the vertical travel of he mold lift.

As shown in FIG. 4, the mold lift cylinder 84 is supported by the second framework 64. The second framework 64 is configured to support the mold lift cylinder 84 in a substantially vertical orientation through the raising and lowering of the mold lift frame 82. The second framework 64 can be any suitable structure.

Referring again to FIG. 4, the mold vibrator 87 is connected to the mold table 79 and positioned between the mold table 79 and the mold lift frame 82. The mold vibrator 87 is configured to vibrate the mold 10, thereby promoting a flow of the castable material into all portions of the sections, 22 and 24, of the cavities 20. In the illustrated embodiment, the mold vibrator 87 is a pneumatic, high-amplitude piston-type vibrator providing a liner force. One example of a pneumatic, piston-type of vibrator is model VTS 50/10, marketed by Powtek Corporation, headquartered in Bensalem, Pa. In other embodiments, the mold vibrator 87 can be other suitable vibrators, such as for example electric or rotary vibrators, sufficient to promote a flow of castable material into all portions of the sections, 22 and 24, of the cavities 20. The mold isolation mechanisms, 86a and 86b, are connected to the mold lift frame 82 and the mold table 79 such that vibration caused by the mold vibrator 87 is substantially limited to the mold 10 and isolated from the mold lift frame 82.

As shown in FIG. 4, the mold 10 is movable in a machine direction D1 by a first conveying mechanism 88. The first conveying mechanism 88 is configured to move the mold 10 to a second conveying mechanism 89. The second conveying mechanism 89 is configured to move the mold to a position atop the mold table 79. In the illustrated embodiment, the first and second conveying mechanisms, 88 and 89, are conveyors. Alternatively, the conveying mechanisms, 88 and 89, can be any device or mechanism sufficient to move the mold 10 to a position atop the mold table 79.

Referring now to FIG. 5, one embodiment of an applicator pan 76a is illustrated. While the applicator pan 76a illustrated in FIG. 5 is representative of the applicator pans 76a-76c, it should be understood that the applicator pans 76a-76c can have different configurations. Generally, the applicator pan 76a includes opposing end walls, 90a and 90b, connected by a formed applicator screen 92. In the illustrated embodiment, the applicator pan 76a is configured to seat against the top surfaces 50a-55a of a corresponding row 78a of the mold cavities 20 and allow a flow of castable material through the applicator pan 76a to the mold cavities 20. In the illustrated embodiment, the applicator pan 76a is made of abrasion-resistant steel and has a thickness TP of approximately 0.1875 inches. In another embodiment, the applicator pan 76a can be made of other materials and can have a thickness TP more or less than 0.1875 inches, sufficient to seat against the top surfaces 50a-55a of a corresponding row 78a of mold cavities 20 and allow a flow of castable material through the applicator pan 76a to the mold cavities 20. In other embodiments, the applicator pan 76a can be covered with coatings configured to reduce the wear of the applicator pan 76a.

As shown in FIG. 5, the applicator screen 92 has four screen sections 94a-94d. The screen sections, 94a and 94d, are substantially vertical sections that are configured not to contact the top surfaces 50a-55a of a corresponding row 78a of mold cavities 20. Rather, the screen sections, 94a and 94d, are configured to support the screen sections 94b and 94c. The screen section, 94b and 94c, are configured to contact the top surfaces 50a-55a of a corresponding row 78a of mold cavities 20. While the embodiment shown in FIG. 5 illustrates four screen sections, 94a-94d, it should be understood that more or less than four screen sections can be used.

As shown in FIGS. 4 and 5, a plurality of connectors 93 suspend the applicator pans, 76a-76c, from the supply hoppers, 72a-72c. The connectors 93 are configured to be flexible thereby allowing the vibration from the pan vibrators, 80a-80c, to be isolated from the supply hoppers, 72a-72c. In the illustrated embodiment, the connectors 93 are flexible steel cables. In other embodiments, the connectors can be other materials, such as for example rubber straps, sufficient to isolate the vibration from the pan vibrators, 80a-80c from the supply hoppers, 72a-72c. While the illustrated embodiment shown in FIG. 5 shows a quantity of four connectors 93, it should be appreciated than more or less than four connectors 93 can be used. In another embodiment, the connectors can take other forms, such as for example sheets of isolating material connecting the screen sections 94c and 94d to the supply hoppers.

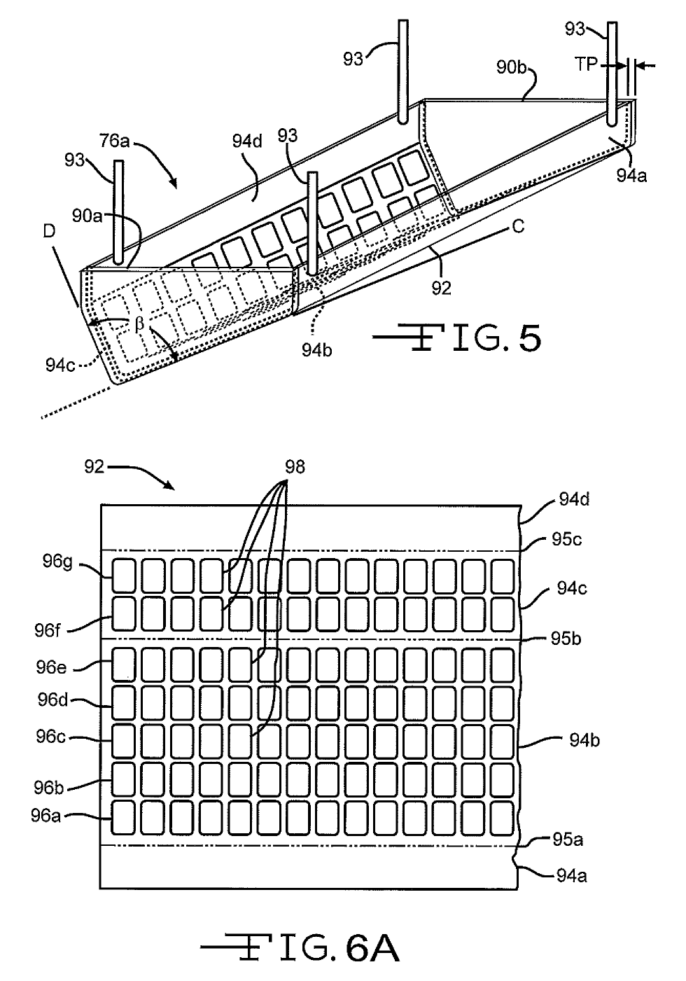

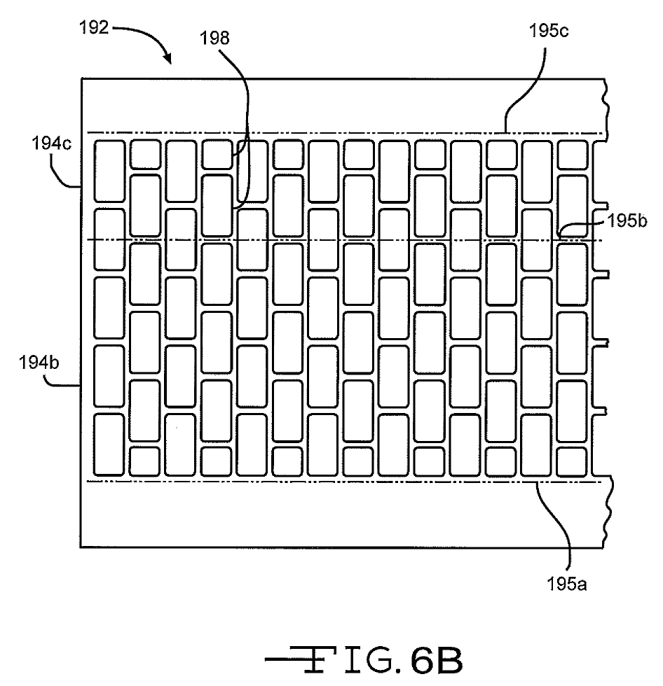

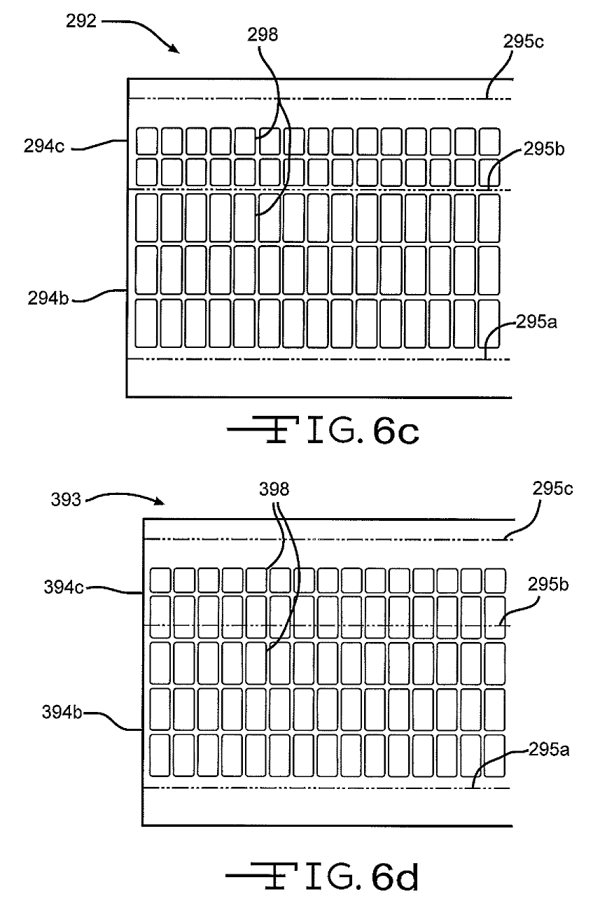

Referring now to FIG. 6A, the applicator screen 92 is illustrated as a flat member prior to forming the four screen sections 94a-94d. The four screen sections 94a-94d are formed by folding the applicator screen 92 along fold lines 95a-95c. As shown in FIG. 6A, the screen sections, 94b and 94c, include substantially horizontal rows 96a-96g of apertures 98. In the illustrated embodiment, the apertures 98 are formed by a process involving laser-based cutting apparatus. In other embodiments, the apertures 98 can be formed by other suitable methods, such as for example by milling.

Referring again to FIG. 6A, the apertures 98 are configured to have a dimensional area corresponding to the rheological properties of the castable material and the maximum aggregate size used in the castable material. The term “rheological properties”, as used herein, is defined to mean those properties of the material defining the defamation and flow of the material. One example of a rheological property is the viscosity of the material. One measure of the viscosity of castable concrete is slump. The term slump, as used herein, is defined to mean the distance the concrete slumps after a molded specimen is removed from an inverted funnel-shaped cone. Castable materials of specific slumps form specific viscosities. The term viscosity, as used herein, is defined to mean the property of a substance that resists the force tending to cause the substance to flow. If the dimensional area of an aperture 98 is small, the rheological properties of the castable material and the maximum aggregate size can prevent the castable material from readily flowing through that aperture. Conversely, if the dimensional area of an aperture 98 is large and the maximum aggregate size is small, the rheological properties of the castable material may allow the castable material to flow freely through the aperture. In this manner, the dimensional area of the apertures 98 can be sized to correspond to the rheological properties of the castable material and the maximum size of the aggregate such that the rheological properties of the castable material substantially prevents the castable material from readily flowing through the apertures 98 without additional influence. As one example, castable material with a maximum aggregate size of ⅜ inch and a slump of 5 inches corresponds to a minimum dimension area of the aperture 98 of 1.25 inches. In one embodiment, the additional influence can be in the form of vibration of the castable material caused by a vibration mechanism. In other embodiments, the additional influence can take other forms, such as for example mechanisms causing increased atmospheric pressure or mechanisms causing a vacuum.

In the embodiment shown in FIG. 6A, the apertures 98 in screen section 94b have the same dimensional area and shape as the apertures 98 in screen section 94c. Likewise, the apertures 98 in screen section 94b are arranged in rows and columns that correspond to the rows and columns of the apertures 98 in screen section 94c. In other embodiments of the applicator screen, 192, 292 and 392 as shown in FIGS. 6B-6D, the apertures, 198, 298 and 398, in screen sections, 194b, 294b and 394c, can have different dimensional areas and shapes from the apertures, 198, 298 and 398 in screen section 194c, 294c and 394c respectively. Likewise, the apertures 198, 298 and 398, in screen sections 194b, 294b and 394b, can be arranged in rows and columns that do not correspond to the rows and columns of the apertures 198, 298 and 398 in screen sections 194c, 294c and 394c.

While the apertures 98, 198, 298 and 398 shown in FIGS. 6A-6D have a rectangular shape, it should be understood that the apertures 98, 198, 298 and 398 can have any shape, such as for example a circular shape, sufficient to provide a dimensional area corresponding to certain rheological properties and maximum aggregate size of the castable material.

Referring again to FIG. 5, the screen section 94b aligns with a first screen section axis C and the screen section 94c aligns with a second screen section axis D. The intersection of the first screen section axis C of the screen section 94b and the second screen section axis D of the screen section 94c forms an applicator pan angle β. The applicator pan angle β is configured to substantially correspond with the cavity angle α of the mold cavity 20. In this embodiment, applicator pan angle β is a 90° angle. Alternatively, the applicator pan angle β can be any angle that corresponds with the cavity angle α, as shown in FIG. 1.

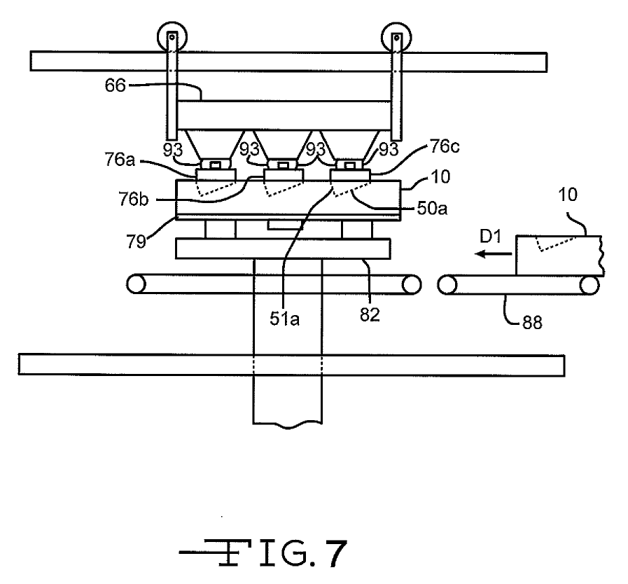

In operation, as shown in FIG. 7, the mold 10 is moved in machine direction D1 on first conveying mechanism 88 to the second conveying mechanism 89. The second conveying mechanism 89 moves the mold 10 to the mold table 79. The mold 10 is indexed on the mold table 79 and positioned underneath the applicator framework 66. The mold 10 is indexed such that the apex of applicator pan angles β of the applicator pans 76a-76c align with the apex of the cavity angles α of the mold cavities 20. As shown in FIG. 7, the mold 10 and the mold table 79 are raised by the mold lift cylinder 84 such that the screen sections, 94b and 94c, of the applicator pans, 76a-76c, contact the first side top surface 50a of the first mold side 50 and the second side top surface 51a of the second mold side 51, respectively. Although the mold 10 is shown as moving upward to the applicator framework 66, it is to be understood that in other embodiments, the applicator framework 66 can be lowered to the mold 10. As shown in FIG. 7, in the raised position, the connectors 93 support the applicator pans, 76a-76c, in a flexed position.

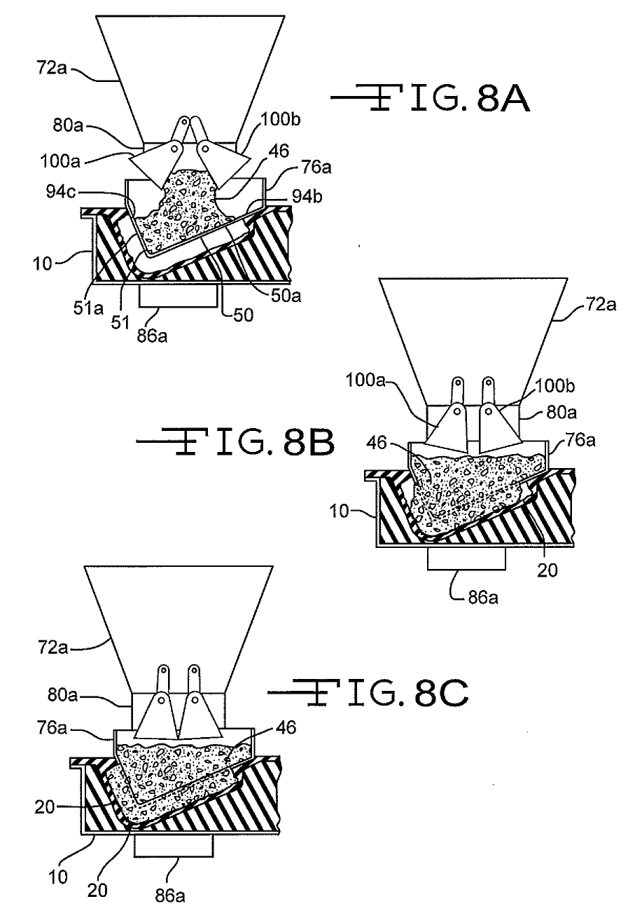

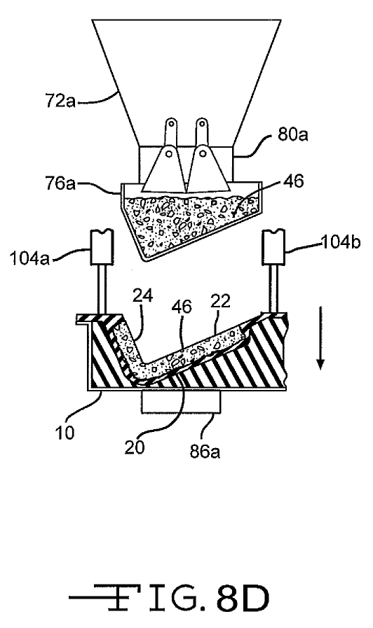

Referring now to FIG. 8A, in the raised position, the first side top surface 50a of the first mold side 50 and the second side top surface 51a of the second mold side 51 are in contact with the screen sections, 94b and 94c. A desired quantity of castable material 46 is deposited into the supply hopper 72a. In this embodiment, the castable material 46 is supplied to the supply hopper 72a from a storage hopper (not shown). In another embodiment, the castable material 46 can be supplied to the supply hopper 72a by another manner, such as by a conveyor or piping, sufficient to supply a desired quantity of castable material 46 into the supply hopper 72a. In this embodiment, an amount of castable material 46 is deposited into the supply hopper 72a sufficient to fill the mold cavities 20. In another embodiment, the quantity of castable material 46 supplied to the supply hopper 72a can be any amount, including more or less than the amount sufficient to fill the mold cavities 20. The supply hopper 72a includes gates 100a and 100b. In a closed position, the gates, 100a and 100b, are configured to retain the castable material in the supply hopper 72a. As the gates, 100a and 100b, open, the gates 100a and 100b are configured to allow the castable material 46 to flow from the supply hopper 72a to the applicator pan 76a. In the illustrated embodiment, the gates, 100a and 100b, are opposing clamshell mechanisms. Alternatively, the gates, 100a and 100b, can be any structure or mechanism, such as for example a sliding gate, sufficient to allow the castable material 46 to flow from the supply hopper 72a to the applicator pan 76a. As the castable material 46 flows into the applicator pan 76a, the castable material 46 does not flow through the apertures 98 in the applicator pan 76a due to the dimensional area of the apertures 98 and corresponding rheological properties and maximum aggregate size of the castable material 46.

Referring now to FIG. 8B, the castable material 46 is urged to flow through the apertures 98 in the applicator pan 76a by activation of the pan vibrator 80a. Activation of the pan vibrator 80a changes the rheological properties of the castable material 46 and allows the castable material 46 to flow through the apertures 98 in the applicator pan 76a and into the mold cavity 20.

As shown in FIG. 8C, at the same time, the mold vibrator 86a is activated. The mold vibrator 86a is configured to vibrate the mold 10 as the castable material 46 flows through the applicator pan 76a into the first and second sections, 22 and 24, of the mold cavity 20. The mold vibrator is well known in the art and can be any mechanism or assembly that vibrates the mold 10 sufficient to urge the castable material 46 to flow into the first and second sections, 22 and 24, of the mold cavity 20. It can be seen that, with the help of the mold vibrator 86a, the castable material 46 can flow by gravity, into and completely fill the mold cavity 20, including both first section 22 and the second section 24. In the embodiment shown in FIG. 8B, the pan vibrator 80a and the mold vibrator 86a are activated for a time period in a range from about 10 seconds to about 60 seconds. In other embodiments, the pan vibrator 80a and the mold vibrator 86a can be activated for a time period less than about 10 seconds or more than about 60 seconds. In other embodiments, the pan vibrator 80a and the mold vibrator 86a can be activated for different and sequential periods of time.

Referring again to the embodiment shown in FIG. 8C, after the cavity 20 is substantially filled with the castable material 46, the pan vibrator 80a and the mold vibrator 86a are deactivated. Deactivating the pan vibrator 80a provides for the rheological properties and the maximum aggregate size of the castable material 46 to prevent the ready flow of the castable material from the applicator pan 76a to the mold 10. Upon deactivation of the pan applicator 80a, a quantity of castable material 46 may remain in the applicator pan 76a. In other embodiments, after the cavity 20 is substantially filled with the castable material 46, the applicator pan 76a may be substantially empty of castable material 46.

Referring now to FIG. 8D, after the castable material 46 has substantially filled the cavity 20, the mold 10 is separated from the applicator pan 76a. In the illustrate embodiment, separation of the mold 10 from the applicator pan 76a is initiated by separation mechanisms 104a and 104b urging the mold 10 in a downward direction. The separation mechanisms, 104a and 104b, are configured to overcome any suction formed between the applicator pan 76a and the castable material 46 in the cavity 20. In the illustrated embodiment, the separation mechanism, 104a and 104b, are air cylinders. Alternatively, the separation mechanisms, 104a and 104b, can be any device of mechanism, such as for example hydraulic rams, sufficient to overcome any suction formed between the applicator pan 76a and the castable material in the cavity and urge the mold in a downward direction. In other embodiments, separation of the mold 10 from the applicator pan 76a can be accomplished in other suitable manners, such as for example forming a layer of pressurized fluid between the applicator pan 76a and the castable material 46. The castable material 46 within the cavity 20 is allowed to substantially harden.

By controlling the flow of the castable material through the apertures of the applicator pan, a reduced volume of the castable material is necessary to manufacture the simulated masonry products. By reducing the volume of castable material required to manufacture the simulated masonry products, the simulated masonry products can be manufactured less costly and more efficiently. In this embodiment, the reduction in the volume of castable material is in a range from about 20% to about 60%. In another embodiment the reduction in the volume of castable material can be more than 60% or less than 20%. The reduced volume of castable material also results in less screeding, since the amount of ovelpour of the castable material can be limited by the deactivation of the pan vibrator. Less screeding results in less labor and more cost effective simulated masonry products.

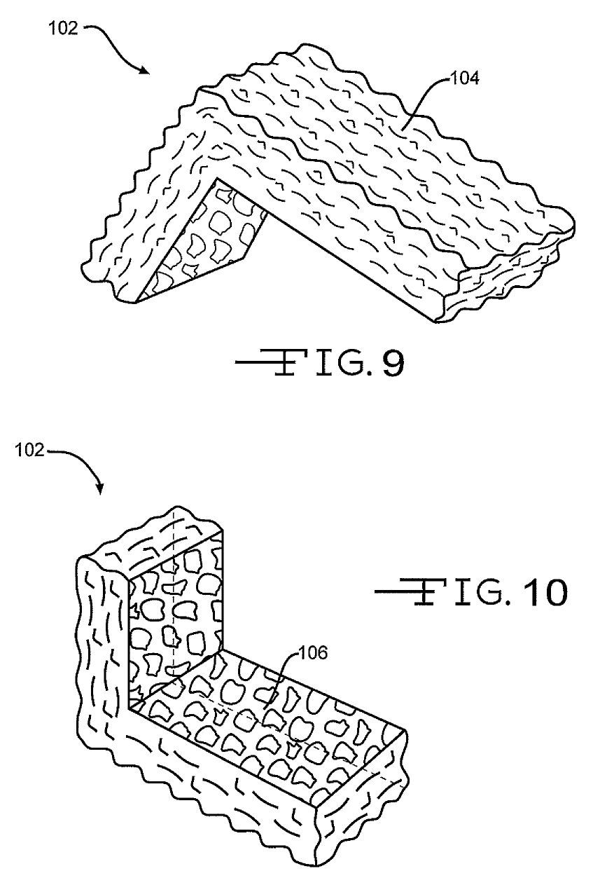

Upon hardening, the castable material 46 in the mold cavities 20 becomes a simulated masonry product 102, which is schematically illustrated in FIGS. 9 and 10. After hardening, the simulated masonry product 102 is removed from the mold cavity 20 in a suitable manner, including passing the mold 10 over rollers. Alternatively, any other method of removing the simulated masonry product 81 from the mold 20, such as introducing a pressurized fluid such as air between the flexible layer 18 and the support material 38, can be used. As shown in FIG. 9, the simulated masonry product 102 can have a textured simulated masonry front face 104. In this embodiment as shown in FIG. 10, the simulated masonry product 102 has a non-textured back face 106. Alternatively, the back face 106 can have any other texture, such as a texture conducive for application to a structural surface.

The principle and mode of operation of this apparatus for simulated masonry products have been described in its preferred embodiments. However, it should be noted that the apparatus for simulated masonry products may be practiced otherwise than as specifically illustrated and described without departing from its scope.

What is claimed is:

1. An apparatus for manufacturing simulated masonry products, the apparatus comprising:
a mold having a mold cavity, the mold cavity having a top surface;
an applicator pan positioned adjacent to the mold, the applicator pan having a screen section positioned above the top surface of the mold cavity, the screen section including an aperture, the aperture configured to prevent castable material residing in the applicator pan from flowing through the aperture and into the mold cavity without additional influence; and
a flow mechanism configured to urge the flow of the castable material through the aperture and into the mold cavity.

2. The apparatus of claim 1 in which the flow mechanism is a vibration apparatus.

3. The apparatus of claim 1 in which the flow mechanism is a pressurizing mechanism.

4. The apparatus of claim 1 in which the flow mechanism is a vacuum apparatus.

5. The apparatus of claim 1 in which the applicator pan includes a formed applicator screen connected to opposing end walls.

6. The apparatus of claim 1 in which the applicator pan is made of abrasion-resistant steel.

7. The apparatus of claim 1 in which the applicator pan includes a plurality of apertures arranged in rows and columns.

8. The apparatus of claim 7 in which the plurality of apertures includes apertures of different sizes and shapes.

9. The apparatus of claim 1 in which the at least one aperture has a generally rectangular shape.

10. The apparatus of claim 1 in which the applicator pan contains castable material, and in which the apertures have a dimensional area that corresponds to the rheological property of the castable material.

11. An apparatus for manufacturing simulated masonry products, the apparatus comprising:
a mold having a mold cavity, the mold cavity having a top surface;
an applicator pan positioned adjacent to the mold, the applicator pan having a screen section positioned above the top surface of the mold cavity, the at least one screen section including an aperture, the aperture configured to prevent castable material residing in the applicator pan from flowing through the aperture and into the mold cavity without additional flow influence; and
a mold vibrator configured to urge the flow of the castable material through the aperture and into the mold cavity.

12. The apparatus of claim 11 in which the applicator pan includes a formed applicator screen connected to opposing end walls.

13. The apparatus of claim 11 in which the applicator pan is made of abrasion-resistant steel.

14. The apparatus of claim 11 in which the applicator pan includes four screen sections.

15. The apparatus of claim 11 in which the applicator pan includes a plurality of apertures arranged in rows and columns.

16. The apparatus of claim 15 in which the plurality of apertures includes apertures of different sizes and shapes.

17. The apparatus of claim 11 in which the at least one aperture has a generally rectangular shape.

18. The apparatus of claim 11 in which the applicator pan contains castable material, and in which the apertures have a dimensional area that corresponds to the rheological property of the castable material.

19. A method for manufacturing simulated masonry products, the method comprising:
providing a mold having a mold cavity, the mold cavity having a top surface;
providing an applicator pan, the applicator pan having a screen section, the screen section including an aperture;
positioning the applicator pan relative to the mold so that the screen section is positioned above and aligned with the top surface of the mold cavity;
providing castable material to the applicator pan, wherein the castable material and the applicator pan are configured to coordinate with each other such that the rheological properties of the castable material are sufficient to prevent the flow of the castable material through the aperture in the applicator pan in the absence of additional flow influences;
urging the flow of the castable material through the aperture of the applicator pan such that the castable material flows into the mold cavities;
allowing the castable material to harden to form simulated masonry products; and
removing the simulated masonry product from the at least one mold cavity.

20. The method of claim 19 in which the castable material is urged to flow through the aperture by a vibration apparatus.
